(19) United States
(12) Patent Application Publication
(10) Pub. No.: US 2021/0293275 A1
(43) Pub. Date: Sep. 23, 2021

(54) PROTECTIVE BEARING ASSEMBLY COVER WITH INTEGRATED CLOSURE

(71) Applicant: Ivan L. Hess, Pendleton, IN (US)

(72) Inventor: Ivan L. Hess, Pendleton, IN (US)

(21) Appl. No.: 16/824,896

(22) Filed: Mar. 20, 2020

(51) Int. Cl. F16C 33/72; F16C 33/76

(52) U.S. Cl. CPC F16C 33/723; F16C 13/006; F16C 33/768

(57) ABSTRACT

A protective cover has an inner surface that is sized and shaped to fit the outer surface of a bearing assembly and includes a main body having two partial sections connectable by a lateral closure such as a zipper. Each partial section defines an outwardly projecting portion that corresponds with the bearing assembly's shaft. The two partial sections are joined to surround and protect a bearing assembly, including the adjoining shaft portions. The covered assembly can be further protected from the environment by applying a sealant to the closure device, and to the interface between the cover and shaft.

### BACKGROUND OF THE INVENTION

The present invention relates to protective covers for mechanical assemblies, and more specifically, to corrosion inhibiting thermoplastic covers with integrated closures for use with bearing assemblies.

Industrial operations such as manufacturing lines often come to a screeching halt when mechanisms malfunction or stop working. These failures are costly, potentially dangerous, and frustrating. Mechanical problems in an industrial operation are particularly troublesome insofar as it isn't usually possible to “swap out” a bad part, so repairs often require shutting down the entire operation.

Corrosion and contamination are leading causes of premature failure in rotating systems such as bearing assemblies. In an effort to prevent these issues, a variety of technologies have developed.

Corrosion Inhibiting Sprayable Thermoplastics (“CISTs”) are used in the industry to protect both stored and operational bearing assemblies. One known delivery method for CISTs is mobilizing spraying equipment and applying the CIST product directly onto the bearing assembly as a hot liquid. This avoids the laborious process of removing bearing assemblies from industrial operations, treating them, and returning them to the underlying structure.

An exemplary device and method of applying CIST in situ is set forth in U.S. Pat. No. 9,211,562 entitled DEVICE AND METHOD FOR MELTING AND SPRAYING THERMOPLASTICS to Boehm et al., which issued on Dec. 15, 2015, and is hereby incorporated in its entirety.

Unfortunately, however, this system presents some challenges. One issue of applying CIST via mobilized spraying is that installed bearing assemblies are often difficult to access with the application equipment due to length of spray hose, size of application equipment, and/or limited access to surfaces with the spray gun. Another issue is the cost of application equipment. Yet another challenge is the significant time that is necessary for application equipment to melt the CIST, which adds to equipment downtime.

In a related technology CIST bearing covers are formed by spraying melted CIST onto a mold, allowing the CIST to cure, cutting and removing the cured cover from the mold, positioning the cover on a mechanical assembly such as a bearing assembly whose shape is significantly identical to the mold, and fusing the cuts on the cover using heat to reform the cover on the mechanical assembly. This overcomes many of the shortcomings of applying CIST in situ.

An exemplary CIST bearing cover is set forth in U.S. Pat. No. 10,300,657 entitled CORROSION INHIBITING SPRAYABLE THERMOPLASTIC COVER FOR MECHANICAL ASSEMBLIES, AND METHODS OF MAKING AND USING to Boehm et al., which issued on May 28, 2019, and is hereby incorporated in its entirety.

Unfortunately, however, this system also presents challenges. Namely, it requires that the mechanical assembly to be covered, including the “tail end” of the shaft, be almost identical to the mold. Also, it requires a heat source, such as a heat gun or flame torch, to fuse together cut portions of the cover. This can be cumbersome and/or dangerous, depending on the specific environment.

As can be seen, there is a need for a protective cover for bearing assemblies that can be used regardless of the length of the shaft's tail end, and that can be installed without a heat source. It is desirable that this cover can be used on bearing assemblies that are hard to access. It is also desirable that this cover is relatively inexpensive, easy to use, and easy to transport. It is also desirable that the cover can be fixed relatively quickly, and with standard tools and equipment.

### SUMMARY OF THE INVENTION

The present invention pertains to corrosion inhibiting covers having integrated closures, for use with bearing assemblies. In a preferred embodiment the bearing assembly cover is sized and shaped to fit a bearing assembly and includes a main body having two separable partial sections, with each partial section including an outwardly projecting end that corresponds with a bearing assembly's shaft. The two partial sections are joined and secured together using an integrated closure such as a zipper with the resulting cover surrounding and protecting a bearing assembly, including the adjoining shaft portions. The covered assembly can be further protected from the environment by applying a sealant to areas such as the closure device, and to the interface region between the cover and shaft.

### BRIEF DESCRIPTION OF THE DRAWINGS

FIG. 1 depicts a side perspective view of a bearing assembly cover with an opened end;

FIG. 2 depicts a side view of the bearing assembly cover of FIG. 1;

FIG. 3 depicts another side perspective view of the bearing assembly cover of FIG. 1 with a closed end;

FIG. 4 is an inside view of the partial sections of the bearing assembly cover of FIG. 1;

FIG. 5 depicts removal of a closed end of a bearing assembly cover;

FIG. 6 depicts a lateral cut being made in a bearing assembly cover; and

FIG. 7 shows some steps of installing a bearing assembly cover with:

FIG. 7A showing an uncovered bearing assembly;

FIG. 7B showing a bearing assembly with the top partial section in place;

FIG. 7C showing a bearing assembly with the top and bottom partial sections in place;

FIG. 7D showing a bearing assembly cover positioned on a bearing assembly with the lateral closure engaged;

FIG. 7E showing a bearing assembly with outer longitudinal closure engaged; and

FIG. 7F showing a covered assembly.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:
10—Bearing assembly cover;
12—Body
13—Partial section;
15—Closed end;
16—Opened end;
17—Shaft projection;
18—Longitudinal cut;
19—Lateral cut;
20—Lateral closure;
25—Inner longitudinal closure;
26—Outer longitudinal closure;
30—Outer layer;
32—Inner layer;
33—Inner surface;
40—Sealant;
50—Uncovered assembly;
52—Bearing;
54—Shaft;
55—Shaft stub; and
60—Covered assembly.

Broadly, the present invention is a cover for a bearing assembly that is formed of two partial sections that are joined together with a closure device such as a zipper to form a unitary body. Each partial section includes one shaft projection having a closed end that can be removed to form an opened end. In use one partial section is positioned on an uncovered assembly, then the second partial portion is positioned, and the two partial portions are connected to form a uniform body that protects the underlying bearing assembly. Sealant is preferably applied to certain areas to more completely shield the bearing assembly from ambient contaminants and corrosives. Bearing assembly covers fit specific bearing assemblies. For example, the cover generally depicted herein is for use with Pillow Block Bearings but other covers having different dimensions that correspond with different bearing assemblies are likewise within the scope of this invention. Examples of other bearing assemblies include (provide a few of the more common ones you do including name of bearing assembly, company, city and state).

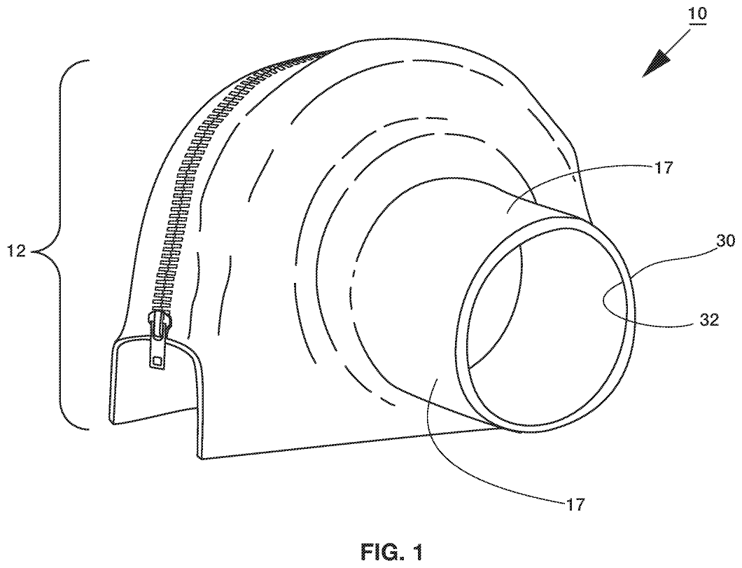

Referring to FIG. 1, bearing assembly cover 10 generally includes body 12 constructed of inner layer 32 and outer layer 30, and defining at least one shaft projection 17. In a preferred embodiment the inner layer is preferably approximately ⅛″ to approximately ¼″ thick, and constructed of thermoplastic, but other materials including thermosets, silicone and plastics are also within the scope of the invention. The outer layer is preferably approximately 1/16″ to approximately ⅛″ thick, and constructed of urethane, but other materials including epoxies and plastics are also possible.

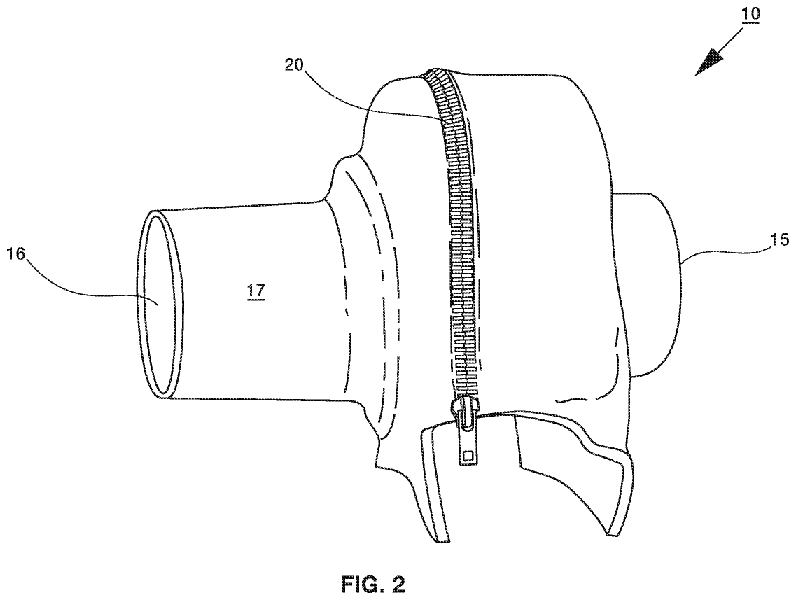

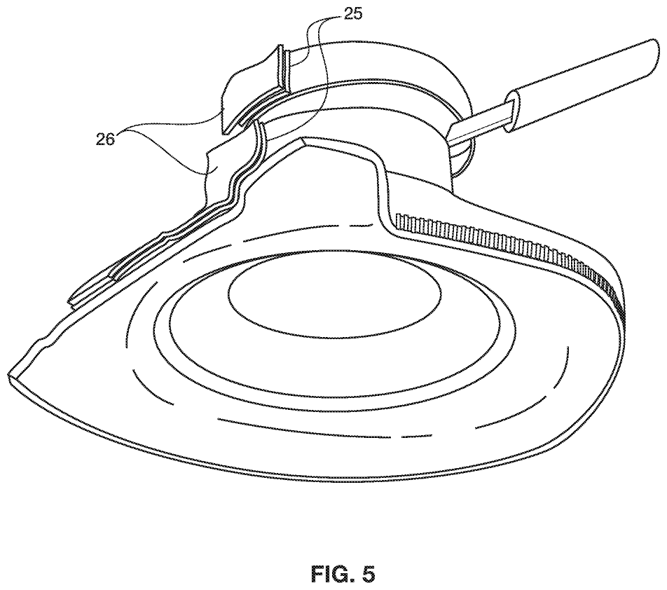

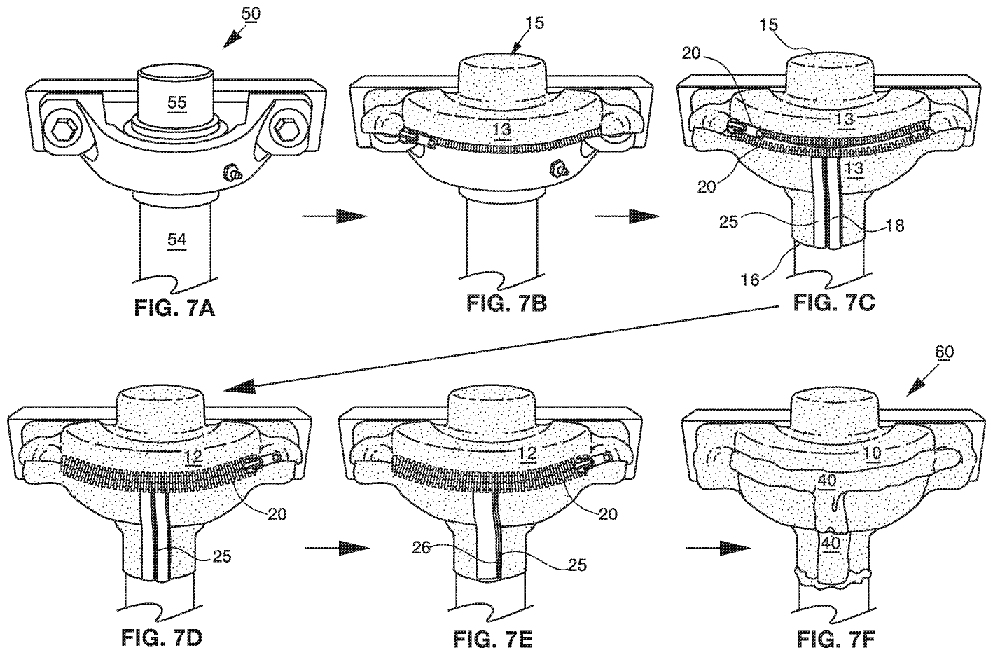

FIG. 2 depicts a side view of the bearing assembly cover with lateral closure 20 engaged and including opened end 16 and closed end 15 on shaft projections 17. Shaft projections 17 are preferably longitudinally aligned to accommodate a shaft passing therethrough. Lateral closure 20 is preferably a zipper, but other closure devices including hook and loop fasteners, snaps, magnets, hook and eyelets, staples and other mechanical fasteners are also possible. In a preferred embodiment, shaft projections 17 are manufactured having closed ends 15, and a user removes the terminal abutment to form open end 16 as needed. This is depicted in FIG. 5. An open end is desirable for wrapping around a proximal portion of shaft 54, while a closed end may be suitable for protecting a shaft stub 55, as shown in FIG. 7A.

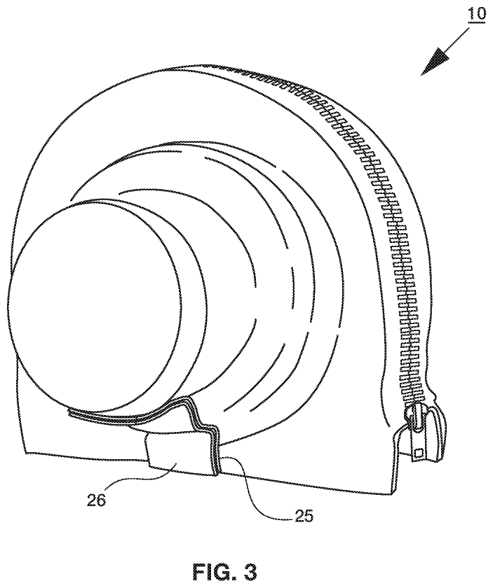

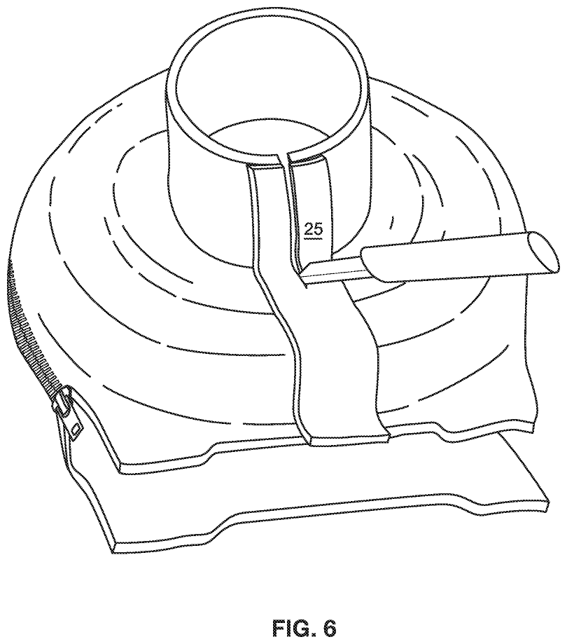

As shown in FIG. 3, the bearing assembly cover preferably includes inner longitudinal closure 25 which is substantially permanently attached to cover, for example by adhesive, and outer longitudinal closure 26 which is releasably engaged with inner longitudinal closure 25. In a preferred embodiment closures 25, 26 are hook and loop fasteners. In use a user would remove outer closure 26 and introduce lateral cut 19 through body 12 and inner closure 25, as shown in FIG. 6. This allows the user to temporarily “open” shaft projection 17 to fit partial section 13 around shaft. Once shaft is within the shaft projection, outer closure 26 is engaged with inner closure 25, thereby holding, or constricting, the lateral cut in a closed or substantially closed position.

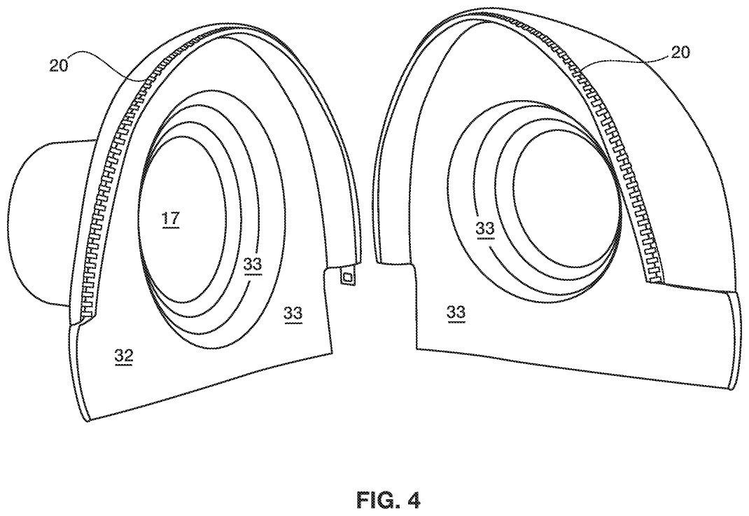

FIG. 4 shows two partial sections 13 each with corresponding portions of lateral closure 20. In a preferred embodiment inner layer 32 is formed by spraying melted thermoplastic onto a mold, allowing the thermoplastic to cure then adding the outer layer and pulling it off the mold. The mold may be a conventional mold, or a bearing may be used as a mold. The inner surface 33 of the inner layer 32, therefore, maintains the topographic detail of the mold/bearing used and fits substantially precisely with the bearing assembly underneath upon installation.

Installation of cover 10 is shown in FIG. 7, with FIG. 7A depicting uncovered assembly 50. The size and shape of uncovered assembly 50 should be substantially similar to inner surface 33 of inner layer 32.

FIG. 7B depicts placement of one partial section 13, this one including closed end 15. FIG. 7C depicts placement of the other partial section 13, this one including opened end 16 and longitudinal cut 18 surrounded by inner longitudinal closure 25. In this figure corresponding sections of lateral closure 20 are not engaged.

FIG. 7D depicts partial sections attached to each other by lateral closure 20, thereby forming unitary body 12. Outer longitudinal closure 26 is engaged in FIG. 7E, thereby holding together longitudinal cut 18 which is under outer closure and not shown.

FIG. 7F depicts bearing assembly cover 10 in position, thereby forming covered assembly 60. In a preferred embodiment sealant 40 is applied to areas that are vulnerable to contaminants and ambient air such as lateral closure and the interface region between the cover and shaft. A properly affixed cover is preferably in substantially consistent contact with underlying assembly. Said another way, there are minimal gaps, preferably less than 2 mm, between the cover and the underlying mechanical assembly.

The foregoing relates to exemplary embodiments of the invention and that modifications may be made without departing from the spirit and scope of the invention as set forth in the following claims. By way of example, the cover could be formed and used with other mechanisms with moving parts, for example gearboxes, or any part requiring corrosion protection such as pipes, valves, flanges and stored parts. Terms such as “substantially” and the like shall mean within reasonable bounds when considering limitations such as machines, materials, manufacturing methods, and people. By way of example, a “substantially smooth” surface means there are no intentional bumps or irregularities. Also, variances are likely to occur with this technology due to gravity, thermoplastic properties, air bubbles, operator differences, and so forth. Material accumulation in certain areas and other irregularities are within the scope of the invention. All ranges set forth herein include the endpoints as well as all increments there between, even if not specifically stated. By way of example 1 to 2 inches includes 1 inch, 1.000001 inches and so forth. Finally, unless otherwise stated or contrary to common sense, “approximate” and the like shall mean+/−10%.

What is claimed is:

1. A protective cover for a bearing assembly including:
A. A first partial section including a first shaft projection and a first lateral closure device;
B. A second partial section completely separable from said first partial section and including a second shaft projection and a second lateral closure device, said second lateral closure device for mating with said first lateral closure device, wherein said first shaft projection and said second shaft projection are longitudinally aligned.

2. The protective cover of claim 1 wherein said first partial section and said second partial section are constructed of an outer layer and an inner layer.

3. The protective cover of claim 2 wherein said inner layer includes material selected from the group consisting of thermoplastic, thermoset, silicone, plastic and combinations thereof.

4. The protective cover of claim 1 wherein said first lateral closure device and said second lateral closure device form a zipper.

5. The protective cover of claim 1 wherein said first partial section includes an inner longitudinal closure device engaged with said first shaft projection.

6. The protective cover of claim 5 further including an outer longitudinal closure device engaged with said inner longitudinal closure device.

7. The protective cover of claim 6 wherein said inner longitudinal closure device and said outer longitudinal closure device are hook and loop fasteners.

8. A protected mechanical assembly including:
A. A bearing assembly; and
B. A multi-sectional protective cover substantially surrounding said bearing assembly, said protective cover including:
i. an inner layer and an outer layer constructed of different materials, said inner layer defining an inner surface and wherein said inner surface is in substantially consistent contact with said bearing assembly; and
ii. A lateral closure device integrated with said inner layer and said outer layer, said closure device releasably attaching one of said multi-sectional sections to another of said multi-sectional sections.

9. The protected mechanical assembly of claim 8 wherein said multi-sectional protective cover defines two longitudinally aligned shaft projections.

10. The protected mechanical assembly of claim 9 wherein at least one of said shaft projections includes an opened end.

11. The protected mechanical assembly of claim 8 wherein said lateral closure device is selected from the group consisting of a zipper, a hook and loop fasteners, snaps, magnets, hook and eyelets, staples and combinations thereof.

12. The protected mechanical assembly of claim 8 further including a sealant applied to said lateral closure device.

13. A method of protecting a bearing assembly including the non-sequential steps of:
A. Selecting a bearing assembly cover having an inner surface that is substantially similar in size and shape to the outer surface of a bearing assembly;
B. Positioning a first partial section of said bearing assembly cover onto the corresponding first portion of said bearing assembly;
C. Positioning a second partial section of said bearing assembly cover onto the corresponding second portion of said bearing assembly; and
D. Releasably engaging said first partial section to said second partial section with a lateral closure device.

14. The method of claim 13 further including the step of introducing a lateral cut to said first partial section prior to positioning said first partial section onto said first portion of said bearing assembly.

15. The method of claim 14 further including the step of constricting said lateral cut with an outer longitudinal closure device.

16. The method of claim 13 further including the step of applying a sealant to said bearing assembly cover.

17. The method of claim 13 wherein said step of releasably engaging said first partial section to said second partial section with a lateral closure device includes the step of zipping a zipper.
